(19) United States
(12) Patent Application Publication
(10) Pub. No.: US 2018/0069429 A1
(43) Pub. Date: Mar. 8, 2018

(54) BI-DIRECTIONAL BATTERY CONVERTER AND BALANCER FOR AN ELECTRIC ENERGY STORAGE OF A POWER SUPPLY SYSTEM

(71) Applicant: ABB Schweiz AG, Baden (CH)

(72) Inventor: Filippo Marbach, Carona (CH)

(21) Appl. No.: 15/810,237

(22) Filed: Nov. 13, 2017

Related U.S. Application Data
(63) Continuation of application No. 14/446,982, filed on Jul. 30, 2014, now abandoned.

(30) Foreign Application Priority Data
Jul. 31, 2013 (EP) 13178659.2

(51) Int. Cl. H02J 9/06; H02J 7/34; H02J 3/28; H02M 3/158; H02J 7/00; H02M 3/155

(52) U.S. Cl. CPC H02J 9/061; H02J 7/345; H02J 3/28; H02M 3/1582; H02M 3/155; H02J 7/0052; Y10T 307/344

(57) ABSTRACT

A power supply system for supplying a load with electric energy from an electrical network can include at least one power supply module. The power supply module can include a DC link to be supplied from the electrical network; and an inverter connected to the DC link and configured to convert a DC voltage from the DC link into an AC voltage to be supplied to the load. An electric energy storage can be charged by the DC link and for supplying the DC link with electric energy, when the electrical network has a power failure, the electric energy storage connected with one input to a neutral point of the power supply module. The power supply module can include a bidirectional buck/boost converter connected to a positive potential or negative potential of the DC link, to the neutral point and to another input of the electric energy storage.

### RELATED APPLICATION(S)

This application claims priority under 35 U.S.C. § 119 to European Application No. 13178659.2 filed in Europe on Jul. 31, 2013, the entire content of which is hereby incorporated by reference in its entirety.

### FIELD

The disclosure relates to the field of power supply systems, for example, to uninterruptable protection systems for train applications. For example, the disclosure relates to a power supply system for supplying a load with electric energy from an electrical network and to a method for operating a power supply system.

### BACKGROUND INFORMATION

In train or railroad systems, an automatic train protection system can enable a safe operation for all vehicles (trains) by supervising and controlling the position and the speed of all vehicles circulating on the railroads. An automatic train protection and other railroad equipment (such as railroad switches, level crossings, railroad lighting, etc.) can use a secure power supply that is adapted to provide auxiliary power to the critical loads of the system for a predetermined amount of time. Such power supply systems can also be called uninterruptable protection systems.

An uninterruptable power supply or protection system can include one or more power supply modules that are adapted for generating an AC output current from an input current supplied by an electrical network. For an AC electrical network, a power supply module can include a rectifier supplying a DC link, which can be interconnected with an inverter for generating the AC output current. In the case of a DC electrical network, the rectifier can be omitted. The inverter and/or rectifier can have a converter topology with two half-bridge phase legs, which can be connected to a split DC link with a centered neutral point. A simple and economical topology can be a half-bridge rectifier and a half-bridge inverter with a split DC link and a neutral/common reference point passing through from input to output. These topologies apply as well to both 4-wire (400 V) and 3-wire (480 V as in North America) systems.

For providing auxiliary energy, when the electrical network is down, an uninterruptable protection system can include an electric energy storage in the form of a rechargeable battery or accumulator. For example, lead acid batteries can be used as electric energy storages in uninterruptable protection systems.

A common battery can be used for several power supply modules, but this can cause operational or cost issues at system level as the battery can introduce a current path that can use complicated or expensive solutions to avoid excessive and/or uncontrolled circulating current between the power supply modules.

Solutions to these issues can include, for example, a three wire battery (for example, a battery with positive, negative and midpoint input) can be used, with the midpoint input centered on a stable reference potential, which can be the neutral point of the power supply system. Such a system can be relatively simple to control and can be inherently stable but a split/three wire battery can result in higher costs due to cabling, protection and the need for two DC-DC converters supporting a two sided or split DC link and charge function.

Another example, a two wire battery (for example, a battery with a positive and negative input) can be used, which can be connected with one input to an unstable but controlled potential, for instance to a potential of a DC link of a power supply module. In this case, the protection and the number of converters can be less, but a control can be more difficult and can include additional impedances and control circuitry between different power supply modules to limit circulating currents via active and passive control to a practical level.

A topology with a battery connected to an unstable potential can additionally be a potentially severe EMI sources, which can include appropriate and costly solutions to conform to regulations. The battery cabling for a large system can also potentially function as a radiating antenna.

### SUMMARY

A power supply system is disclosed for supplying a load with electric energy from an electrical network, the power supply system comprising: at least one power supply module, having a DC link to be supplied from an electrical network, and an inverter connected to the DC link and configured to convert a DC voltage from the DC link into an AC voltage to be supplied to the load; an electric energy storage for charging by the DC link, and for supplying the DC link with electric energy when the electrical network has a power failure, the electric energy storage being connected with one input to a neutral point of the power supply module; at least two capacitors interconnected in series between a positive potential and a negative potential of the DC link, wherein a neutral point is provided between the at least two capacitors; a first bidirectional buck/boost converter for charging and discharging the electric energy storage connected to the positive potential or the negative potential of the DC link, to the neutral point, and to another input of the electric energy storage; and a second bidirectional buck/boost converter for balancing electric energy stored in the at least two capacitors interconnecting the neutral point, the negative potential and the positive potential of the DC link.

A method for operating a power supply system is disclosed, the method comprising: charging an electric energy storage from a DC link of at least one power supply module of the power supply system with a first bidirectional buck/boost converter, wherein the electric energy storage is connected with one input to a neutral point of the power supply module and with another input to the buck/boost converter, wherein the bidirectional buck/boost converter is connected to a positive potential or negative potential of the DC link and is connected with the neutral point; and supplying the DC link with electric energy by discharging the electric energy storage via the bidirectional buck/boost converter to the DC link.

A controller for a power supply system is disclosed, the power supply system including at least one power supply module, having a DC link to be supplied from an electrical network, and an inverter connected to the DC link and configured to convert a DC voltage from the DC link into an AC voltage to be supplied to the load, an electric energy storage for charging by the DC link, and for supplying the DC link with electric energy when the electrical network has a power failure, the electric energy storage being connected with one input to a neutral point of the power supply module, at least two capacitors interconnected in series between a positive potential and a negative potential of the DC link, wherein a neutral point is provided between the at least two capacitors, a first bidirectional buck/boost converter for charging and discharging the electric energy storage connected to the positive potential or the negative potential of the DC link, to the neutral point and to another input of the electric energy storage, and a second bidirectional buck/boost converter for balancing electric energy stored in the at least two capacitors interconnecting the neutral point, the negative potential and the positive potential of the DC link, the controller being configured to: charge an electric energy storage from a DC link of at least one power supply module of the power supply system with a first bidirectional buck/boost converter, wherein the electric energy storage is connected with one input to a neutral point of the power supply module and with another input to the buck/boost converter, wherein the bidirectional buck/boost converter is connected to a positive potential or negative potential of the DC link and is connected with the neutral point; and supply the DC link with electric energy by discharging the electric energy storage via the bidirectional buck/boost converter to the DC link.

### BRIEF DESCRIPTION OF THE DRAWINGS

The subject matter of the disclosure will be explained in more detail in the following text with reference to exemplary embodiments which are illustrated in the attached drawings, in which:

FIG. 1 schematically shows an exemplary power supply system in accordance with an exemplary embodiment of the disclosure;

FIG. 2 schematically shows a part of an exemplary power supply module in accordance with an exemplary embodiment;

FIG. 3 schematically shows an exemplary converter for a power supply in accordance with an exemplary embodiment; and

FIG. 4 shows a flow diagram for an exemplary method for operating a power supply system in accordance with an exemplary embodiment.

### DETAILED DESCRIPTION

In accordance with an exemplary embodiment, the disclosure can provide a simple, relatively easy to control and inexpensive uninterruptable protection system.

In accordance with an exemplary embodiment, the disclosure relates to a power supply system for supplying a load with electric energy from an electrical network. The electric network can be a large scale grid, such as a 16⅔ Hz AC train voltage network, a 230 V/50/60 Hz network or DC network. The load or loads can include a train protection system and railroad equipment such as sensors, switches, etc.

In accordance with an exemplary embodiment, the power supply system can include one or more power supply modules, each of which can include a rectifier (only in the case of an AC input electrical network), a DC link and an inverter connected in series. In the case of a plurality of power supply modules, these modules can be connected in parallel to the electrical network.

In accordance with an exemplary embodiment, the power supply module (or all power supply modules) can include a DC link to be supplied from the electrical network (for example via a rectifier) and an inverter connected to the DC link and adapted for converting the DC voltage from the DC link into an AC voltage to be supplied to the load. The power supply system can include an electric energy storage to be charged by the DC link and for supplying the DC link with electric energy, for example, when the electrical network has a power failure. The electric energy storage can be connected with one input to a neutral point of the power supply module. The power supply module can include a bidirectional buck/boost converter, which can be connected to a positive or negative potential of the DC link, to the neutral point and to another input of the electric energy storage.

A bidirectional buck/boost converter can be a DC-DC converter with a half-bridge and an inductivity connected to the midpoint of the half-bridge. With the bidirectional buck/boost converter, the electric energy storage can be charged or discharged, which can allow a load share with a rectifier connected to the DC link, for example, for overload or for battery diagnostics. It can be noted that only one single bi-directional converter for charging/discharging the electric energy storage can be provided between the electric energy storage and the DC link, which can simplify the system and its control, and can save cabling and components.

Furthermore, the bidirectional buck/boost converter can support either but not both parts of a split DC link. The bidirectional buck/boost converter can be rated for full system power.

Also the electrical energy storage, which can be a rechargeable battery or accumulator, connected to an input of the bidirectional buck/boost converter and to a system stable neutral potential, can be rated for full system power. Since the electric energy storage can be connected to a stable potential shared by all power supply modules, for example, a common neutral point, no uncontrolled circulating currents between power supply modules can be present.

In accordance with an exemplary embodiment, the DC link can be a split and/or two-sided DC link, for example can include two capacitors interconnected in series between the positive and the negative potential of the DC link, wherein the neutral point is provided between the two capacitors, for example, at a midpoint of the split DC link. In this way, one end of the electric energy storage can be connected to the midpoint and to one side of a two-sided DC link.

In accordance with an exemplary embodiment, the electric energy storage can include only two inputs, for example, can be a battery with only two terminals, such as a simple standard acid lead accumulator. Such a battery connection can be the simplest possible. The topology can utilize a two wire battery with one end connected to a stable neutral potential in a power supply module, for example, a neutral potential of the overall power supply system.

In accordance with an exemplary embodiment, a battery can provide an additional benefit due to a practical commercial component availability, which can allow a simple realization of a ‘battery charger’ function at up to rated system power. This can be of importance in areas of very weak utility or alternative energy applications. This topology can also allow use of three wire legacy batteries without connecting the midpoint.

In accordance with an exemplary embodiment, the power supply module can include a bidirectional buck/boost converter interconnecting the neutral point, the negative potential and the positive potential of the DC link. The above disclosed first bidirectional buck/boost converter can be a charging/discharging converter. The second converter can be a balancing converter for balancing loads between the parts of a split DC link and/or between different DC links under system dynamical situations.

With the balancing converter, a DC component of an AC current to the DC link can be controlled to maintain regulation and balance of the AC and DC components of the currents, for example, during charging of the electric energy storage.

In accordance with an exemplary embodiment, during an unbalanced loading of different DC link, the balancing converter can compensate different loads by an energy transfer between two or more DC links.

In accordance with an exemplary embodiment, each power supply module can include a first buck/boost converter interconnecting an electric energy storage with one half or part of the DC link and a second buck/boost converter for transferring energy needed for load support for the opposite half cycle to the respective other half of the DC link.

In accordance with an exemplary embodiment, the first buck/boost converter and/or the further, second buck/boost converter include a half-bridge (two semiconductor switches connected in series) providing a first output and a second output and an inductivity connected with one end to an midpoint of the half-bridge (between the two semiconductor switches) and providing with another end a third output. Both of the buck/boost converters can be bi-directional, wherein the first converter can function as a charger with the same components thus having a very high potential charge capability.

The first buck/boost converter and/or the second buck/boost converter furthermore can include two diodes, each diode connected in parallel to one of the semiconductor switches.

In accordance with an exemplary embodiment, the buck/boost converter interconnected with the electric energy storage can be connected with the first output to the electric energy storage, with the second output to the neutral point and with the third output to the positive or negative potential of the DC link. For example, during charging, the voltage of the electric energy storage can be higher than the voltage of the positive (or negative) potential of the DC link.

In accordance with an exemplary embodiment, the buck/boost converter interconnected with the electric energy storage can be connected with the first output to the positive or negative potential of the DC link, with the second output to the neutral point and with the third output to the electric energy storage. For example, during discharging, the voltage of the positive (or negative) potential of the DC link can be higher as the voltage of the electric energy storage.

In accordance with an exemplary embodiment, the further, second buck/boost converter can be connected with the first output to the positive potential of the DC link, with the second output to the negative potential of the DC link and with the third output to the neutral point.

In accordance with an exemplary embodiment, the power supply system can include a plurality of power supply modules, each power supply module including a DC link connected to the electric energy storage. In accordance with an exemplary embodiment, all power supply modules can be equally designed and can all have two buck/boost converters as disclosed herein, which can result in a scalable and/or modular power supply system, including individual parallel power supply modules. The module can have either independent electric energy storages or a common electric energy storage, which in both cases can include lead acid batteries.

In accordance with an exemplary embodiment, the power supply modules can be connected via their neutral points, which can be connected to one input of the electric energy storage; wherein each power supply module can include a bidirectional buck/boost converter interconnecting the other input of the electric energy storage with a positive potential or negative potential of the DC link of the respective power supply module. For example, the balancing buck/boost converters can be additionally used for balancing loads between the power supply modules via the common neutral point.

In accordance with an exemplary embodiment, a method for operating a power supply system is disclosed, which can be designed as disclosed herein. For example, the method can be performed by a controller of the power supply system. The method can be implemented in the controller as a computer program (for example, software) or can be implemented at least partially in hardware. It can be understood that features of the method as disclosed herein can be features of the power supply system as disclosed herein.

In accordance with an exemplary embodiment, the method can include charging an electric energy storage from a DC link of at least one power supply module of the power supply system with a bidirectional buck/boost converter, wherein the electric energy storage can be connected with one input to a neutral point of the power supply module and with another input to the buck/boost converter, wherein the bidirectional buck/boost converter can be connected to a positive or negative potential of the DC link and can be connected with the neutral point; and supplying the DC link with electric energy by discharging the electric energy storage via the bidirectional buck/boost converter to the DC link. A single DC-DC converter can be used for either charging or discharging the electric energy storage via only one leg of a split DC link. In accordance with an exemplary embodiment, no uncontrolled and/or circulating current can be present, for instance, in a 4-wire installation (for example, standard 400 V installation, phases and neutral). Furthermore, the electric energy storage can be at a stable reference potential.

In accordance with an exemplary embodiment, the method can include balancing electric energy stored in DC link capacitors of the power supply module, for example, during discharging of the electric energy storage, by operating a further buck/boost converter interconnecting the neutral point, the negative potential and the positive potential of the DC link. With an additional second bi-directional converter, energy can be transferred from the part of the DC link supported by the first converter to the opposite part of the DC link or vice versa to maintain a regulation. The balancing converter can compensate for a DC component on an AC input current during charging of the electric energy storage and/or support of an unbalanced, for example, half wave rectified load.

In accordance with an exemplary embodiment, the method can include charging the electric energy storage of at least one power supply module of the power supply system with the bidirectional buck/boost converter, wherein a DC component of a current drawn from an electrical network is actively controlled through the further buck/boost converter.

In accordance with an exemplary embodiment, the method can include balancing electric energy between at least two DC links of at least two power supply modules of the power supply system via buck/boost converters, the power supply modules being interconnected via their DC link neutral points and each power supply module including a buck/boost converter interconnecting the respective neutral point, the respective negative potential and the respective positive potential of the DC link of the respective power supply module. The second converter connected via a common neutral point between DC links can selectively and bi-directionally transfer energy from DC link to DC link to maintain individual link regulation, for example, under steady state conditions and/or under dynamic conditions.

For example, the use of the second converter can allow for DC link control under dynamic conditions (independently from the charging and discharging function of the first converter), for example, a reverse energy flow from the inverter of a power supply module under dynamic load conditions or severe instances of unbalanced link loading, for example when connecting to a large inductive load (such as a transformer). In accordance with an exemplary embodiment, this can help prevent a potential system shut down due to an uncontrollable DC link overshoot.

In accordance with an exemplary embodiment, a controller is disclosed for a power supply system as disclosed herein, which can be adapted for performing the exemplary methods as disclosed herein. The system level control as well as the controller can be very simple as all common points can be at reference or can be independently and individually controlled. In accordance with an exemplary embodiment, no additional hardware or control at the parallel system level is needed.

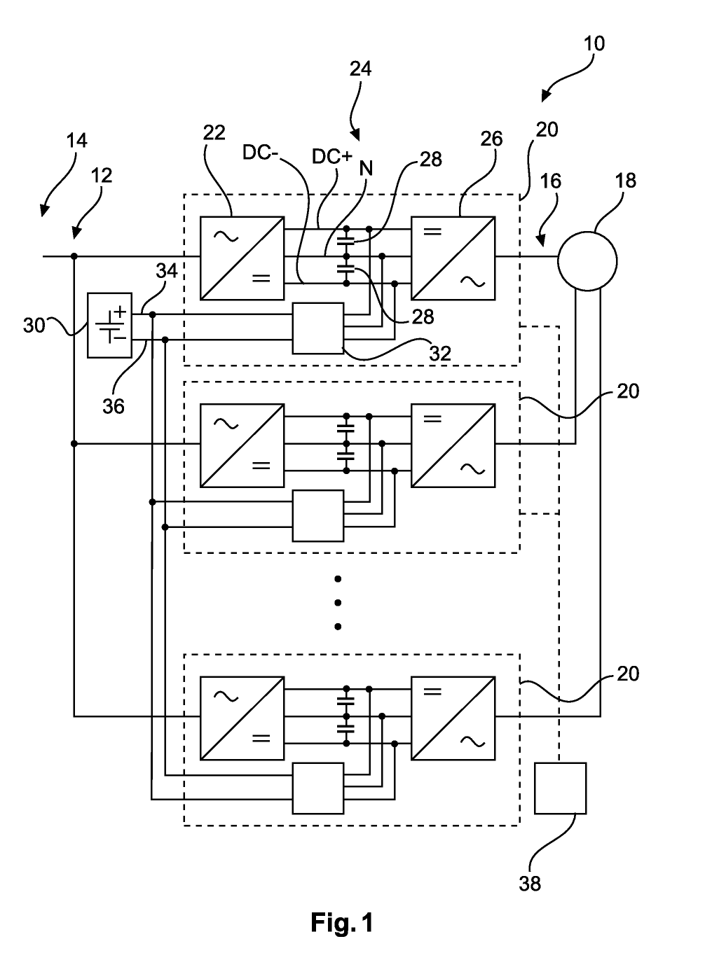

FIG. 1 shows a power supply system 10 that at an input 12 can be connected to an electrical network 14 and at an output 16 can be connected to one or more loads 18. The power supply system 10 can be part of an uninterruptable protection system, for example for train or railroad applications. The electrical 14 network can be a (single phase) 16⅔ Hz railroad network or can be a (three phase) 230 V/50/60 Hz network.

The power supply system 10 can include a plurality of equally designed power supply modules 20 connected in parallel to the electrical network 14 at the input 12. For reasons of clarity, only the first power supply module 20 is provided with reference numerals. However, all power supply modules can include equal components.

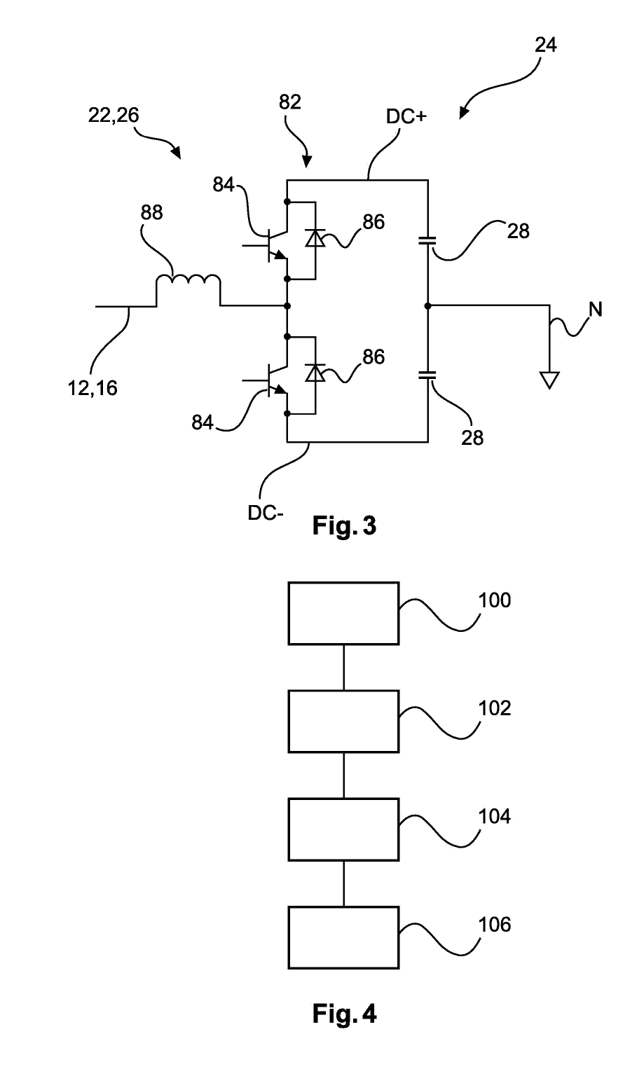

Each power supply module 20 can include a rectifier 22, a DC link 24 and an inverter 26 connected in series between the input 12 and the output 16. The rectifier 22 and the inverter 26 can be designed as shown in FIG. 3 and disclosed herein. The split DC link can include two capacitors 28 connected in series between a positive potential DC+ and a negative potential DC−, which can have a midpoint which provides a neutral point potential N.

Furthermore, each power supply module 20 can include an energy converter 32 for transferring energy between an electric energy storage 30 and the DC link 24, between the upper and lower capacitor 28 of one DC link 24 and between the DC links 24 of different power supply modules 20.

The common electric energy storage 30 can include an acid lead battery with two inputs 34, 36 that are connected to the energy converters 32, which are connected in parallel to the electric energy storage 30.

Additionally, the power supply system 10 can include a controller 38 that can be adapted to control all power supply modules 20, for example, the rectifiers 22, inverters 26 and the energy converters 32. The controller 38 can receive sensor inputs from current and voltage sensors all over the system 10, from which all voltages and current in the system 10 can be derived. These voltages and currents can be regulated by the control of the controller 38.

As indicated in FIG. 1, the controller 38 can be a central controller. Alternatively, the controller 38 can be distributed among the power supply modules 20.

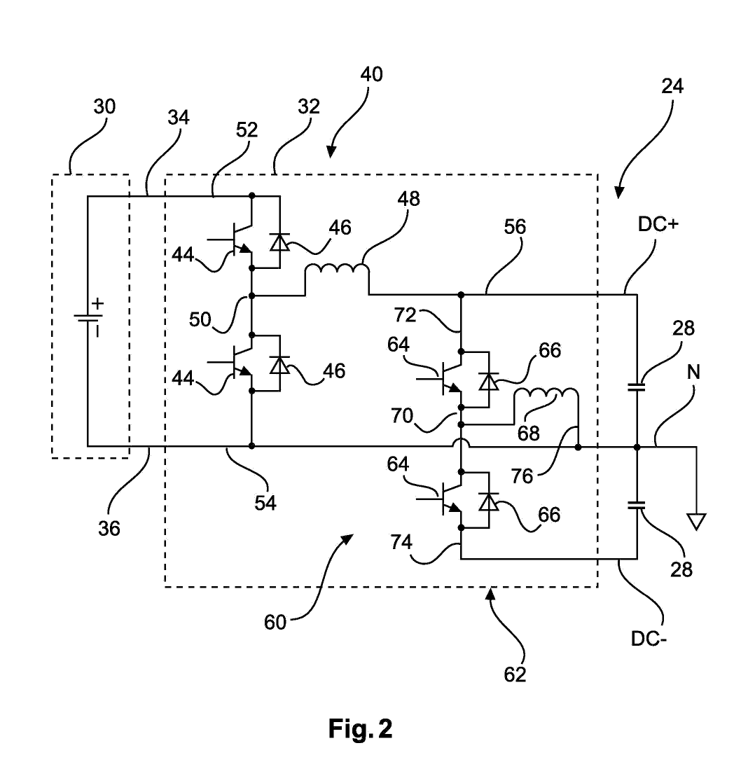

FIG. 2 shows details of the exemplary energy converter 32, which on one side is connected to the positive potential DC+, the neutral point potential N and the negative potential of the DC link 24 and on another side is connected to the inputs of the electric energy storage 30.

In accordance with an exemplary embodiment, it can be noted that the neutral point potential N can be directly connected with the negative input 26 of the electric energy storage. For example, all neutral point potentials N of all power supply modules 20 can be directly connected.

The energy converter 32 can include a first buck/boost converter 40 for charging and discharging the electric energy storage, which can include a half-bridge 42 with two semiconductor switches (transistors) 44 connected in series that are switched by the controller 38. A diode 46 can be connected in parallel to each semiconductor switch 44. An inductivity 48 can be connected to a midpoint 50 between the two semiconductor switches 46. The half-bridge 42 can provide a first output 52 on one end, that can be connected with the positive input 34 of the electric energy storage 30 and at a further end, a second output 54 can be connected with the neutral point potential N. A third output 56 of the converter 40 can be provided by the inductivity 48 that can be connected with the positive potential DC+ of the DC link 24.

In accordance with an exemplary embodiment, the output 52 can be connected with the positive potential DC+ and that the output 56 can be connected with the input 34 of the electric energy storage. In accordance with an exemplary embodiment, the first converter can be connected to the negative potential DC− with either the output 54 or the output 56.

The energy converter 32 can include a second buck/boost converter 60 for balancing energy between the capacitors 28 of the DC link 24 and between different DC links 24. The second converter 60 can include the same components as the first converter 40. The second converter can include a half-bridge 62 with two semiconductor switches (transistors) 64 connected in series that can be switched by the controller 38. A diode 66 can be connected in parallel to each semiconductor switch 64. An inductivity 68 can be connected to a midpoint 70 between the two semiconductor switches 66. The half-bridge 62 can provide a first output 72 on one end can be connected with the positive potential DC+ and at a further end, a second output 74 can be connected with the negative potential DC−. A third output 76 of the converter 60 can be provided by the inductivity 68 that can be connected with the neutral point potential N.

FIG. 3 shows a topology of the converters 22, 26 of the power supply module 20. The converters 22, 26 can be designed analogously to the converters 40, 60. A half-bridge 82 with two semiconductor switches (transistors) 84 connected in series that are switched by the controller 38 can interconnect the positive potential DC+ and the negative potential DC−. A diode 86 can be connected in parallel to each semiconductor switch 84. An inductivity 88 can be connected to a midpoint between the two semiconductor switches 86. The other end of the inductivity 88 can provide the input 12 or output 16 of the power supply module 20.

FIG. 4 shows a method for operating a power supply system 10, which can be performed by the controller 38.

In step 100, the controller can detect that the electric energy storage needs to be charged and that the electric network 14 is up. This, for example, can be the case after the startup of the power supply system 10 or after a power failure of the electrical network 14. In accordance with exemplary embodiment, the controller 38 charges the electric energy storage 30 from the DC link 24 of at least one power supply module 20 of the power supply system 10. For example, to achieve this, the switches 44 of the bidirectional buck/boost converter 40 can be switched such that energy from the DC link 24 can be transferred to the electric energy storage 30. In addition, the converter 60 can balance energy transferred to the energy storage 30 from both DC links in such a way that the current from the electric network 14 can be substantially balanced and does substantially have no DC component.

In step 102, the controller 38 can detect that the DC link 24 needs to be supplied with energy from the electric energy storage 30. For example, this can be the case, when the electrical network 14 has a power failure. In this case, the controller 38 can discharge the electric energy storage 30 via the bidirectional buck/boost converter 40 to the DC link 24. For example, to achieve this, the switches 44 of the bidirectional buck/boost converter 40 can be switched such that energy from the electric energy storage 30 can be transferred to the DC link 24.

In step 104, the controller 38 can balance electric energy stored in the DC link capacitors 28. In accordance with an exemplary embodiment, this can be performed during discharging of the electric energy storage 30. The controller 38 can operate the switches 64 of the further, second buck/boost converter 60 such that energy from the upper capacitor can be transferred to the lower capacitor 28.

In step 106, the controller 38 can detect that the energy distribution between the DC links 24 of the power supply modules 20 is not balanced. The controller can balance the electric energy between at least two DC links 24 of at least one power supply modules 20 of the power supply system 10 via the buck/boost converters 60 by switching the switches 64 correspondingly.

While the disclosure has been illustrated and described in detail in the drawings and foregoing description, such illustration and description are to be considered illustrative or exemplary and not restrictive; the disclosure is not limited to the disclosed embodiments. Other variations to the disclosed embodiments can be understood and effected by those skilled in the art and practising the claimed disclosure, from a study of the drawings, the disclosure, and the appended claims. In the claims, the word “comprising” does not exclude other elements or steps, and the indefinite article “a” or “an” does not exclude a plurality. A single processor or controller or other unit can fulfil the functions of several items recited in the claims. The mere fact that certain measures are recited in mutually different dependent claims does not indicate that a combination of these measures cannot be used to advantage. Any reference signs in the claims should not be construed as limiting the scope.

Thus, it will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

1.-20. (canceled)

21. A power supply system for supplying a load with electric energy from an electrical network, the power supply system comprising:
at least one power supply module, having a DC link to be supplied from an electrical network, and an inverter connected to the DC link and configured to convert a DC voltage from the DC link into an AC voltage to be supplied to the load;
an electric energy storage for charging by the DC link, and for supplying the DC link with electric energy when the electrical network has a power failure, the electric energy storage being connected with one input to a neutral point of the power supply module;
at least two capacitors interconnected in series between a positive potential and a negative potential of the DC link, wherein a neutral point is provided between the at least two capacitors;
a first bidirectional buck/boost converter for charging and discharging the electric energy storage connected to the positive potential or the negative potential of the DC link, to the neutral point, and to another input of the electric energy storage, wherein the first bidirectional buck/boost converter comprises a first half-bridge of two series connected semiconductor switches and a first inductivity connected to a first midpoint of the first half-bridge; and
a second bidirectional buck/boost converter for balancing electric energy stored in the at least two capacitors interconnecting the neutral point, the negative potential and the positive potential of the DC link, wherein the second bidirectional buck/boost converter comprises a second half-bridge of two series connected semiconductor switches and a second inductivity connected to a second midpoint of the second half-bridge.

22. The power supply system of claim 21, comprising:
only two inputs for the electric energy storage.

23. The power supply system of claim 21, wherein the first half-bridge provides a first output and a second output for the first bidirectional buck/boost converter;
wherein the first inductivity connected with one end between the two semiconductor switches of the first half-bridge provides a third output for the first bidirectional buck/boost converter;
wherein the second half-bridge provides a first output and a second output for the second bidirectional buck/boost converter; and
wherein the second inductivity connected with one end between the two semiconductor switches of the second half-bridge provides a third output for the second bidirectional buck/boost converter.

24. The power supply system of claim 23, comprising:
two diodes, each of the two diodes connected in parallel to one of the two semiconductor switches of the first half-bridge and/or the second half-bridge.

25. The power supply system of claim 23, wherein the first bidirectional buck/boost converter for charging and discharging the electric energy storage is connected with the first output to the electric energy storage, with the second output to the neutral point, and with the third output to the positive potential or negative potential of the DC link.

26. The power supply system of claim 24, wherein the first bidirectional buck/boost converter for charging and discharging the electric energy storage is connected with the first output to the electric energy storage, with the second output to the neutral point, and with the third output to the positive potential or negative potential of the DC link.

27. The power supply system of claim 23, wherein the first bidirectional buck/boost converter for charging and discharging the electric energy storage is connected with the first output to the positive potential or to the negative potential of the DC link, with the second output to the neutral point, and with the third output to the electric energy storage.

28. The power supply system of claim 24, wherein the first bidirectional buck/boost converter for charging and discharging the electric energy storage is connected with the first output to the positive potential or to the negative potential of the DC link, with the second output to the neutral point, and with the third output to the electric energy storage.

29. The power supply system of claim 23, wherein the second bidirectional buck/boost converter is connected with the first output to the positive potential of the DC link, with the second output to the negative potential of the DC link, and with the third output to the neutral point.

30. The power supply system of claim 21, comprising:
a plurality of power supply modules, each of the plurality of power supply modules including a DC link connected to the electric energy storage.

31. The power supply system of claim 29, comprising:
a plurality of power supply modules, each of the plurality of power supply modules including a DC link connected to the electric energy storage.

32. The power supply system of claim 30, wherein each of the plurality of power supply modules is connected via their neutral points, to one input of the electric energy storage.

33. The power supply system of claim 32, wherein each of the plurality of power supply modules comprises:
a bidirectional buck/boost converter interconnecting an input of the electric energy storage with a positive potential or a negative potential of the DC link of a respective power supply module.

34. The power supply system of claim 31, wherein each of the plurality of power supply modules is connected via their neutral points connected to one input of the electric energy storage.

35. The power supply system of claim 34, wherein each of the plurality of power supply modules includes a bidirectional buck/boost converter interconnecting an input of the electric energy storage with a positive potential or a negative potential of the DC link of the respective power supply module.

36. A method for operating a power supply system, the method comprising:
charging an electric energy storage from a DC link of at least one power supply module of the power supply system with a first bidirectional buck/boost converter, wherein the electric energy storage is connected with one input to a neutral point of the power supply module and with another input to the first bidirectional buck/boost converter, wherein the first bidirectional buck/boost converter is connected to a positive potential or negative potential of the DC link and is connected with the neutral point and wherein the first bidirectional buck/boost converter comprises a first half-bridge of two series connected semiconductor switches and a first inductivity connected to a first midpoint of the first half-bridge;
supplying the DC link with the electric energy by discharging the electric energy storage via the first bidirectional buck/boost converter to the DC link; and
balancing electric energy stored in DC link capacitors of the power supply module during discharging of the electric energy storage by operating a second bidirectional buck/boost converter interconnecting the neutral point, the negative potential and the positive potential of the DC link, wherein the second bidirectional buck/boost converter comprises a second half-bridge of two series connected semiconductor switches and a second inductivity connected to a second midpoint of the second half-bridge.

37. The method of claim 36, comprising:
charging the electric energy storage from the DC link of at least one power supply module of the power supply system with the first bidirectional buck/boost converter, wherein a DC component of a current drawn from an electrical network is actively controlled through the second bidirectional buck/boost converter.

38. A controller for a power supply system, the power supply system including at least one power supply module, having a DC link to be supplied from an electrical network, and an inverter connected to the DC link and configured to convert a DC voltage from the DC link into an AC voltage to be supplied to the load, an electric energy storage for charging by the DC link, and for supplying the DC link with electric energy when the electrical network has a power failure, the electric energy storage being connected with one input to a neutral point of the power supply module, at least two capacitors interconnected in series between a positive potential and a negative potential of the DC link, wherein a neutral point is provided between the at least two capacitors, a first bidirectional buck/boost converter for charging and discharging the electric energy storage connected to the positive potential or the negative potential of the DC link, to the neutral point and to another input of the electric energy storage, wherein the first bidirectional buck/boost converter comprises a first half-bridge of two series connected semiconductor switches and a first inductivity connected to a first midpoint of the first half-bridge, and a second bidirectional buck/boost converter for balancing electric energy stored in the at least two capacitors interconnecting the neutral point, the negative potential and the positive potential of the DC link, wherein the second bidirectional buck/boost converter comprises a second half-bridge of two series connected semiconductor switches and a second inductivity connected to a second midpoint of the second half-bridge, the controller being configured to:
charge an electric energy storage from a DC link of at least one power supply module of the power supply system with the first bidirectional buck/boost converter, wherein the electric energy storage is connected with one input to a neutral point of the power supply module and with another input to the first bidirectional buck/boost converter, wherein the first bidirectional buck/boost converter is connected to a positive potential or negative potential of the DC link and is connected with the neutral point; and
supply the DC link with electric energy by discharging the electric energy storage via the first bidirectional buck/boost converter to the DC link.

39. The controller of claim 38, configured to:
balance electric energy stored in the at least two capacitors of the power supply module during discharging of the electric energy storage by operating a second bidirectional buck/boost converter interconnecting the neutral point, the negative potential and the positive potential of the DC link; and
charge the electric energy storage from the DC link of at least one power supply module of the power supply system with the bidirectional buck/boost converter, wherein a DC component of a current drawn from an electrical network is actively controlled through the second buck/boost converter.
